(19) United States
(12) Patent Application Publication
(10) Pub. No.: US 2012/0087056 A1
(43) Pub. Date: Apr. 12, 2012

(54) INDUCTION TOUCH KEY

(76) Inventor: Shao-Ji Huang, Sanchong City (TW)

(21) Appl. No.: 12/898,720

(22) Filed: Oct. 6, 2010

(51) Int. Cl. H01H 47/12

(52) U.S. Cl. 361/179

(57) ABSTRACT

The present invention provides an induction touch key, which comprising: a touch key unit with at least a conductor layer and an insulation layer; a first resistor electrically connected with the conductor layer; a processing unit electrically connected with the first resistor; A second resistor electrically connected with the processing unit; a switch electrically connected with the second resistor and processing unit. When the insulation layer is touched manually, the processing unit is used to detect the change of surface charge, and then output a start signal to drive the switch for an improved safety.

### BACKGROUND OF INVENTION

1. Field of the Invention

The present invention relates generally to an induction touch key, and more particularly to an innovative one which allows starting the switch through the change of surface charge for improved operational safety.

2. Description of Related Art

A conventional touch key (shown in FIG. 3) comprises a pressing portion 81 and two contact points 82, 83 separately below the pressing portion 81; when an external force is applied to the pressing portion 81, the pressing portion 81 will contact two contact points 82, 83 for conducting startup.

Notwithstanding the aforementioned function, the mechanical design pressing portion 81 will often bring about poor contact or possible damage against the pressing portion 81, leading to potential electric shock or malfunction of other devices with lowered safety of the touch key 8.

### SUMMARY OF THE INVENTION

The primary objective of the present invention is that, when the insulation layer is touched manually, a processing unit is used to detect the change of surface charge, and then output a start signal to drive the switch for an improved safety.

For this purpose, the present invention provides an induction touch key, which comprising: a touch key unit with at least a conductor layer and insulation layer; a first resistor electrically connected with the conductor layer; a processing unit electrically connected with the first resistor; a second resistor electrically connected with the processing unit; and a switch electrically connected with the second resistor and processing unit.

### DETAILED DESCRIPTION OF THE INVENTION

Referring to FIG. 1—a schematic view of the framework of the present invention, wherein the induction touch key of the present invention comprises a touch key unit 1, a first resistor 2, a processing unit 3, a second resistor 4 and a switch 5.

Said touch key unit 1 at least comprises a conductor layer 11 and an insulation layer 12 superimposed on the conductor layer 11.

The first resistor 2 is electrically connected with the conductor layer 11 of the touch key unit 1; and the first resistor 2 is an impedance matching resistor.

The processing unit 3 is electrically connected with the first resistor 2; and the processing unit 3 is a unit for charge detection and signal processing.

The second resistor 4 is electrically connected with the processing unit 3; and the second resistor 4 is a limit resistor. The switch 5 is electrically connected with the second resistor 4 and processing unit 3; and the switch 5 is a relay.

Referring to FIG. 2—the operation view of the present invention, wherein the processing unit 3 is connected with the switch 5 and power unit 6, while the electronic device 7 is connected with the switch 5; when the insulation layer 12 of the touch key unit 1 is manually touched by the user, the surface charge of the insulation layer 12 may change (namely, change of equivalent capacitance). In such case, the processing unit 3 will conduct relevant detection and analysis; when the change of surface charge of insulation layer 12 is detected and analyzed by the processing unit 3, the processing unit 3 will output a start signal to drive the switch 5 along with the second resistor 4, thereby activating the electronic device 7; since the user's hands are insulated from the conductor layer 11 through the insulation layer 12, it is possible to prevent electric shock and improve the operational safety.

To sum up, when the insulation layer is touched manually, the processing unit is used to detect the change of surface charge, and then output a start signal to drive the switch, thus improving the safety and applicability of the induction touch key of the present invention. The above is a detailed description of the technical features of the present invention based on a typical preferred embodiment. However, it should be appreciated that the present invention is capable of a variety of embodiments and various modifications by those skilled in the art, and all such variations or changes shall be embraced within the scope of the following claims.

### BRIEF DESCRIPTION OF THE DRAWINGS

FIG. 1 depicts a schematic view of the framework of the present invention.

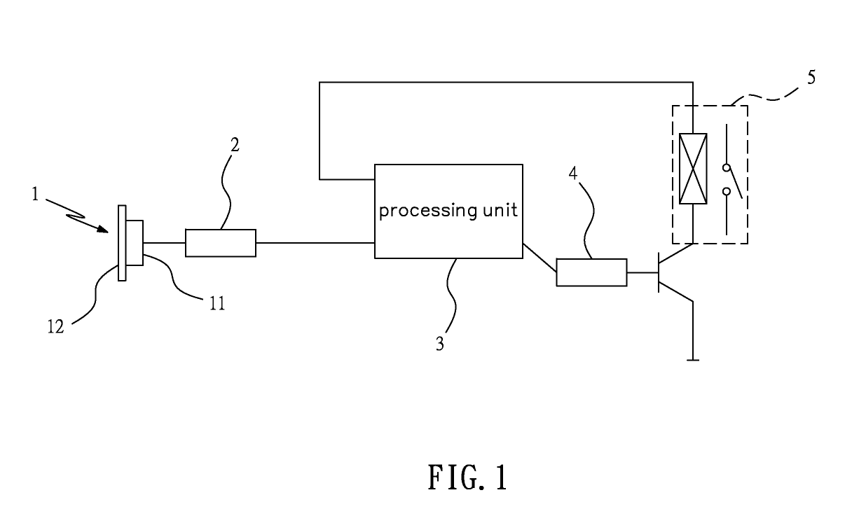

FIG. 2 depicts an operation view of the present invention.

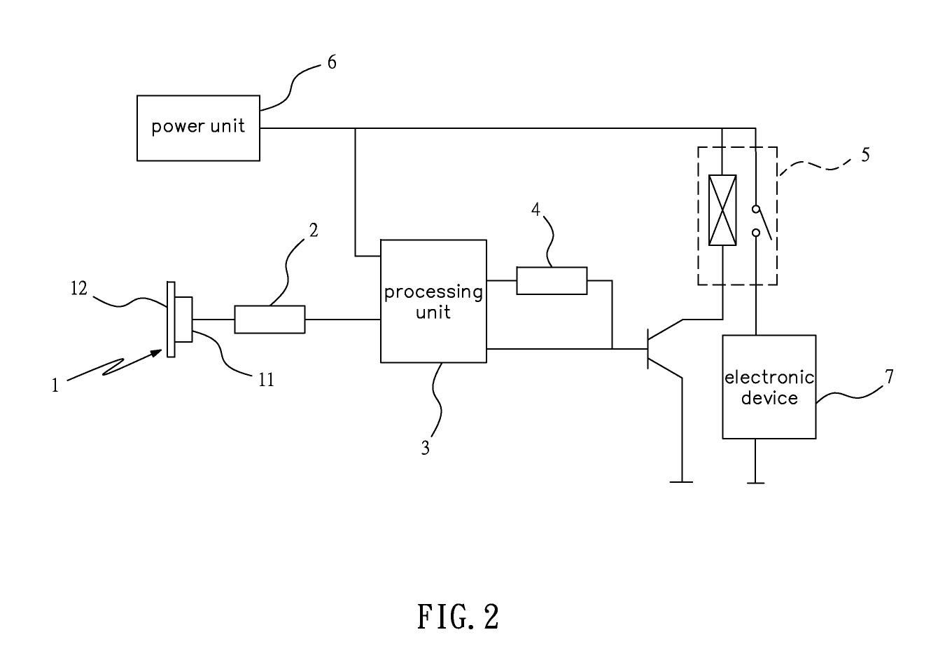

FIG. 3 depicts an operation view of a typical invention.

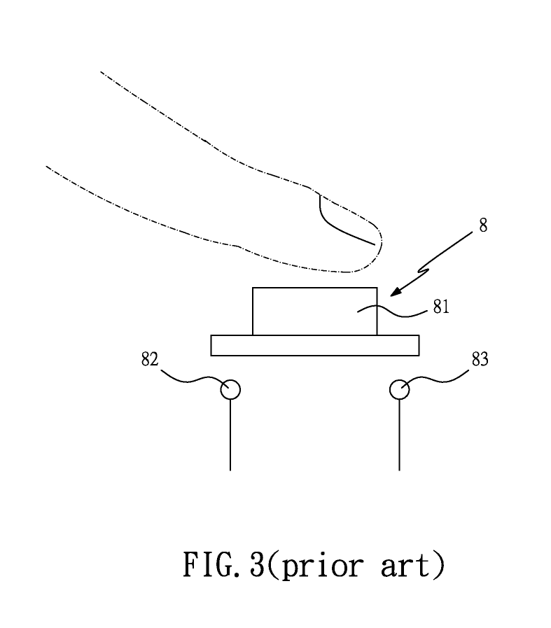

What is claimed is:

1. An induction touch key, comprising:
a touch key unit, with at least a conductor layer and an insulation layer superimposed on the conductor layer;
a first resistor, electrically connected with the conductor layer of the touch key unit;
a processing unit, electrically connected with the first resistor;
a second resistor, electrically connected with the processing unit, and
a switch, electrically connected with the second resistor and processing unit.

2. The induction touch key defined in claim 1, wherein said first resistor is an impedance matching resistor.

3. The induction touch key defined in claim 1, wherein said processing unit is a unit for charge detection and signal processing.

4. The induction touch key defined in claim 1, wherein said second resistor is a limit resistor.

5. The induction touch key defined in claim 1, wherein said switch is a relay.
